(19) United States
(12) Patent Application Publication
(10) Pub. No.: US 2014/0196241 A1
(43) Pub. Date: Jul. 17, 2014

(54) FLAT WIPER BLADE ASSEMBLY

(71) Applicant: KCW Corporation, Daegu (KR)

(72) Inventors: Kwan Hee KIM, Daegu (KR); Jae Hyuck AN, Daegu (KR); Woo Sung LEE, Daegu (KR)

(73) Assignee: KCW Corporation, Daegu (KR)

(21) Appl. No.: 14/151,530

(22) Filed: Jan. 9, 2014

(30) Foreign Application Priority Data
Jan. 11, 2013 (KR) 10-2013-0003563

(51) Int. Cl. B60S 1/38

(52) U.S. Cl. CPC B60S 1/3858
USPC 15/250.32

(57) ABSTRACT

A flat wiper blade assembly may be provided that includes: a flat wiper blade; and an adaptor part which includes an adaptor including a pair of guide plate members which is connected to the flat wiper blade and projects perpendicularly at an interval, and a connector which is coupled to the adaptor and couples a wiper arm to the flat wiper blade. A pair of the guide plate members includes an embossed member formed on an outer wall thereof.

### CROSS-REFERENCE TO RELATED APPLICATIONS

This application claims the benefit of Korean Patent Application No. 10-2013-0003563, filed on Jan. 11, 2013, which is incorporated by reference herein in its entirety.

### BACKGROUND

1. Field

The present invention relates to a flat wiper blade assembly.

2. Description of Related Art

In general, a wiper blade removes impurities, snow, rain or the like when driving and prevents a driver's front sight from being deteriorated and performs a repetitive reciprocating action in a fan shape as a motor drives a link apparatus connected to a wiper arm.

The wiper blade includes a long wiper strip contacting with a glass surface and a frame maintaining and supporting the wiper strip in a longitudinal direction of the wiper strip. The wiper blade including the frame is known as a conventional wiper blade in the art. Recently, a wiper blade is being employed which makes use of one frame curved at a predetermined curvature and formed in the form of a long thin bar. Such a wiper blade is known as a flat wiper blade or a flat-bar wiper blade in the art.

As compared with the conventional wiper blade, the flat wiper blade has a less height and receives less air resistance. With a uniform load, the flat wiper blade is also able to cause the wiper strip to contact with the glass surface. A flat wiper blade assembly including the flat wiper blade includes an adaptor part disposed in the central portion of the frame. The flat wiper blade assembly is connected to the wiper arm such that the adaptor part is separably connected to the end portion of the wiper arm.

The adaptor part includes an adaptor and a connector. The adaptor is coupled to the flat wiper blade. The connector is coupled to the adaptor and couples the wiper arm to the flat wiper blade. Here, the upper portion of the adaptor includes a pair of guide plates formed projecting perpendicularly at a predetermined interval.

For the purpose of preventing a gap from occurring between the adaptor and the connector when the flat wiper blade of the flat wiper blade assembly is operated, the guide plate is thick. For example, since the guide plate of 1.5 T is employed, the flat wiper blade assembly becomes heavier and not only requires a higher manufacturing cost caused by the increase of the material but also is disadvantageous in the manufacturing process thereof.

### SUMMARY

One embodiment is a flat wiper blade assembly including a flat wiper blade; and an adaptor part which includes an adaptor including a pair of guide plate members which is connected to the flat wiper blade and projects perpendicularly at an interval, and a connector which is coupled to the adaptor and couples a wiper arm to the flat wiper blade. A pair of the guide plate members includes an embossed member formed on an outer wall thereof.

According to the embodiment, the guide plate member has a thickness of 1.2 T to 1.3 T.

According to the embodiment, the guide plate member has a shape in which the embossed member projects outwardly from the outer wall and in which portions corresponding to the embossed member are formed inwardly concave in mutually facing inner walls.

According to the embodiment, the embossed member is formed to include a plurality of ribs separated from each other at a predetermined interval.

According to the embodiment, the adaptor includes a first pin-hole and a second pin-hole to which the wiper arm is coupled in a side direction thereof, and the embossed member is formed to contact with the first pin-hole and the second pin-hole.

According to the embodiment, the flat wiper blade assembly further includes a cover which is fixed to the adaptor coupled to the flat wiper blade and is used to prevent impurities.

According to the embodiment, the width of the cover is greater than that of the adaptor.

### BRIEF DESCRIPTION OF THE DRAWINGS

FIG. 1 is a perspective view showing a flat wiper blade assembly according to the present invention;

FIG. 2 is a perspective view showing that the flat wiper blade assembly of FIG. 1 has been separated from an adaptor part;

FIGS. 3a and 3b are perspective views showing respectively one end and the other end of a wiper strip 10 of FIG. 2;

FIG. 4 is a perspective view showing an adaptor of FIG. 2;

FIG. 5 is a perspective view showing that an embossed member of FIG. 4 has been formed to have a smiling shape having a straight line;

FIG. 6 is a perspective view showing that the embossed member of FIG. 4 has been formed to have a smiling shape bent one time;

FIG. 7 is a perspective view showing that the embossed member of FIG. 4 has been formed to have a smiling shape bent twice;

FIG. 8 shows another embodiment of the adaptor of the present invention;

FIG. 9 is a perspective view showing that the flat wiper blade assembly according to the present invention has been separated from a wiper arm; and

FIG. 10 is a perspective view showing that the flat wiper blade assembly according to the present invention has been coupled to the wiper arm of FIG. 9.

### DETAILED DESCRIPTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

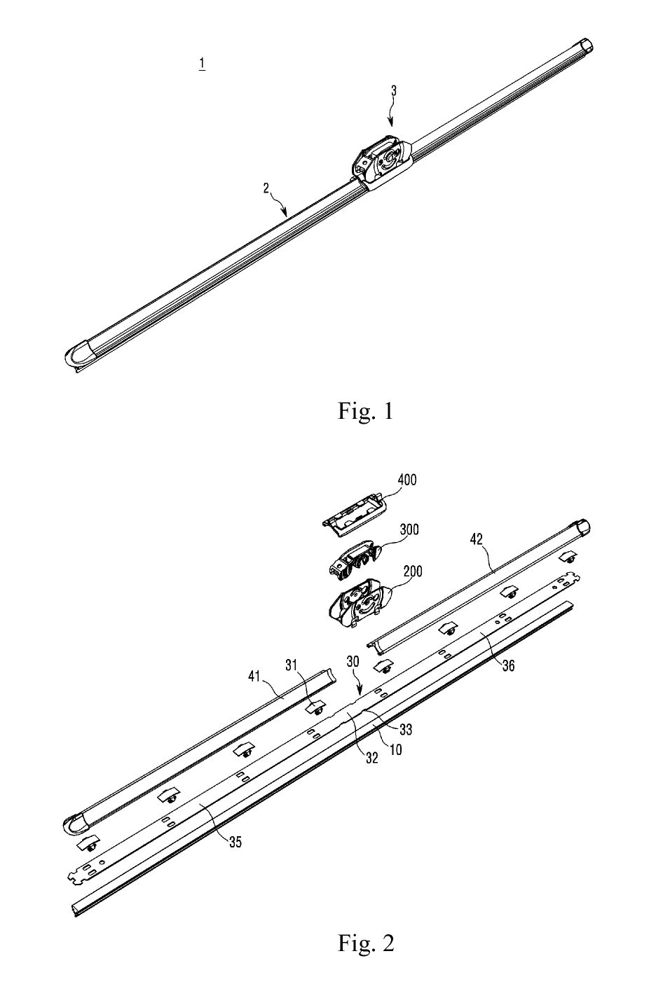

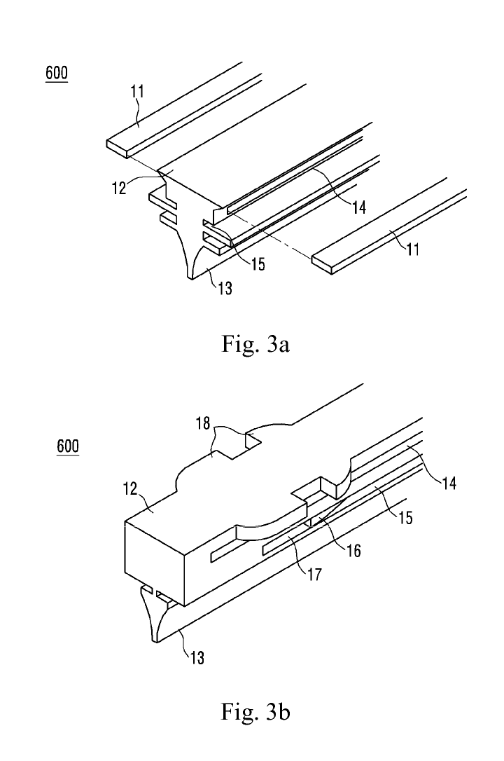

FIG. 1 is a perspective view showing a flat wiper blade assembly according to the present invention. FIG. 2 is a perspective view showing that an adaptor part has been separated from the flat wiper blade assembly of FIG. 1. FIGS. 3a and 3b are perspective views showing respectively one end and the other end of a wiper strip 10 of FIG. 2.

As shown in FIG. 1, the flat wiper blade assembly 1 according to the present invention includes a flat wiper blade 2 contacting closely with the glass surface of a vehicle, and includes an adaptor part 3 assembled to the central portion of the flat wiper blade 2 so as to connect the flat wiper blade 2 to a wiper arm (not shown).

As shown in FIGS. 1 and 2, the flat wiper blade 2 includes the wiper strip 10 which contacts closely with and wipes the glass surface of the vehicle, a frame 30 which is disposed on the wiper strip 10 and supports the wiper strip 10, and a first spoiler 41 and a second spoiler 42 which are coupled to the frame 30. Also, as shown in FIGS. 3a and 3b, the flat wiper blade 2 may further include two backing plates 11 which are mounted on the wiper strip 10.

As shown in FIGS. 1 and 2, the adaptor part 3 includes an adaptor 200 which is coupled to the frame 30 of the flat wiper blade 2, and a connector 300 which is coupled to the adaptor 200 and couples the wiper arm to the flat wiper blade 2. Also, the adaptor part 3 may further include a cover 400 which is used to prevent impurities from penetrating the adaptor 200 coupled to the frame 30. Here, the shape of the coupleable connector 300 is changed depending on the wiper arm. The adaptor part 3 is formed by coupling the adaptor 200 and the connector 300 as separate components. However, there is no limit to this. The adaptor part 3 may be formed by integrally configuring the adaptor 200 and the connector 300 in the form of one component.

Hereafter, the flat wiper blade 2 will be described in detail.

The flat wiper blade 2 is connected to the front end of the wiper arm and receives a pressing force from the wiper arm with respect to the glass surface of the vehicle. The wiper arm rotates reciprocatively at a predetermined angle by a wiper motor (not shown). Accordingly, the flat wiper blade 2 wipes the glass surface (wiping surface) of the vehicle within the predetermined angle.

As shown in FIGS. 2, 3a and 3b, the wiper strip 10 extends in a longitudinal direction thereof and is made of an elastic material like a rubber material or made of an elastic composite material. The wiper strip 10 is disposed to contact with the glass of the vehicle in a sliding manner and removes impurities of the glass surface.

The wiper strip 10 includes a base member 12 and a wiping lip 13. The base member 12 is supported by the frame 30. The wiping lip 13 is disposed under the base member 12 and contacts directly with and wipes the glass surface.

The base 12 is supported by a fastener 31 of the frame 30. The fastener 31 may have a yoke shape. A receiving recess 14 in which the two parallel backing plates 11 are received extends in the base 12 in a longitudinal direction thereof. The two rectangular metallic backing plates 11 having spring characteristics are received in the two backing plate receiving recesses 14 respectively.

Also, a holding portion 15 in which the fastener 31 is received in a sliding manner extends in the base member 12 in the longitudinal direction thereof. Here, as shown in FIG. 3a, the holding portion 15 at the one end of the wiper strip 10 is open so as to receive the fastener 31. However, as shown in FIG. 3b, the other end of the wiper strip is formed to limit the longitudinal direction movement of the fastener 31. That is, one of the fasteners 31 of the frame 30, which is located at one end of the wiper strip 10, is limited by a coupling member 17 and a wall of a slope 16 provided only at the other end of the holding portion 15. Also, the longitudinal direction movement of the fastener 31 is limited by a protrusion 18.

The base member 12 and the wiping lip 13 continuously extend in a longitudinal direction of the wiper strip 10.

The wiper strip 10 and the frame 30 have a long thin shape in the major axial direction of the flat wiper blade 2. The wiper strip 10 and the frame 30 are coupled to each other through the fastener 31.

The frame 30 includes a first and a second side members 35 and 36 which are located on both ends thereof, and a central member 32 located approximately in the center between the first and the second side members 35 and 36. The first and the second spoilers 41 and 42 are coupled to the first and the second side members 35 and 36 respectively. The adaptor part 3 is coupled to the central member 32.

Also, a fitting recess member 33 is formed in a portion of the longitudinal direction side of the frame 30 in such a manner as to be concave in the width direction of the flat wiper blade 2.

Here, recesses are formed in the first and the second side members 35 and 36 at a predetermined interval, so that the fastener 31 can be inserted and fixed into the recess from the top surface to the bottom surface of the frame 30. However, the separate fastener 31 is not necessarily inserted and fixed into the recess. The fastener 31 may be integrally formed with the frame 30. Also, the fitting recess member 33 is located approximately in the center of the frame 30.

The backing plate 11 applies elasticity and rigidity to the wiping lip 13. When a pressurizing force is applied from the wiper arm, the pressurizing force is distributed to the wiper strip 10 through the frame 30. Here, the pressurizing force is distributed by the backing plate 11 in the longitudinal direction of the wiper strip 10. Accordingly, the backing plate 11 should have elasticity and rigidity to maintain the shape of the wiper strip 10. A plurality of the backing plates 11 and a plurality of the backing plate receiving recesses 14 may be provided according to the rigidity or elasticity of the wiper strip.

Hereafter, the adaptor 200 will be described in detail.

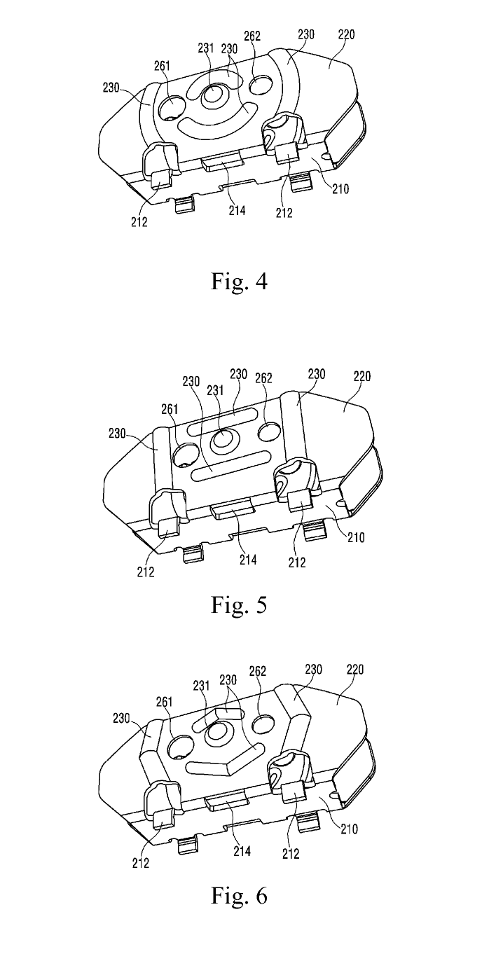

FIG. 4 is a perspective view showing an adaptor of FIG. 2.

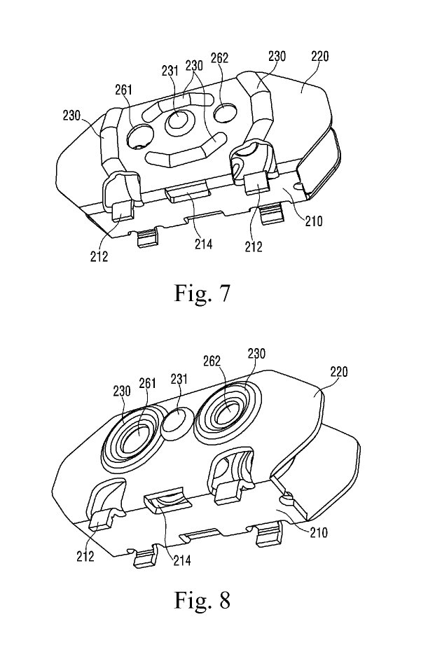

FIG. 5 is a perspective view showing that an embossed member of FIG. 4 has been formed to have a smiling shape having a straight line. FIG. 6 is a perspective view showing that the embossed member of FIG. 4 has been formed to have a smiling shape bent one time. FIG. 7 is a perspective view showing that the embossed member of FIG. 4 has been formed to have a smiling shape bent twice.

The adaptor 200 is designed to contact with and be coupled to the frame 30, and to support the adaptor part 3. While the body of the adaptor 200 is formed in parallel with the frame 30, it is preferable that that the bottom surface of the body is in contact with the top of the frame 30 and supports the body at the time of being coupled to the frame 30.

As shown in FIG. 4, the adaptor 200 includes a body 210 which is parallel with the frame 30 in the central portion of the flat wiper blade 2, and a pair of guide plate members 220 which is connected to the body 210 and projects perpendicularly at a predetermined interval. Here, the body 210 of the adaptor 200 comes in contact with the frame 30, and the guide plate member 220 comes in contact with the connector 300.

The body 210 functions to fasten the adaptor 200 to the frame 30. It is preferable that the body 210 includes a projecting member 212 which is formed longitudinally in both ends of the body 210 in such a manner as to enclose from the outside and fix the fitting recess member 33 of the frame 30, and a fitting hole member 214 which is formed in both side ends of the central portion of the body 210.

The guide plate member 220 is coupled to the connector 300 and performs a function to support the connector 300. According to the present invention, a pair of the guide plate members 220 includes an embossed member 230 including a plurality of ribs separated from each other at a predetermined interval. For example, the embossed member 230 is formed as a whole in the form of a smiling face. Here, the embossed member 230 is formed in the form of a plurality of ribs separated from each other at a predetermined interval, for example, as shown in FIGS. 4 to 7, may be formed in the form of a circular arc-shaped smiling face, a straight line-shaped smiling face, a once bent smiling face, and a double bent smiling face. Also, the embossed member 230 may be formed in different shapes through the implementation of various embossing forms (shape, depth, and formation direction of the embossment).

The embossed member 230 is formed on the outer wall of a pair of the guide plate members 220. The embossed member 230 is formed to project outwardly from a pair of the guide plate members 220. Here, in a pair of the guide plate members 220, portions corresponding to the embossed member 230 are formed inwardly concave in mutually facing inner walls of a pair of the guide plate members 220.

The rigidity of the guide plate member 220 is enhanced as a whole because the embossed member 230 functions to sustain the guide plate member 220. Hereby, a plate member having a thickness of 1.2 T to 1.3 T can be used as the guide plate member 220.

Also, a first pin-hole 261 and a second pin-hole 262 are formed on the middle end of the guide plate member 220. A wiper arm “pa” with a pin projecting in the side direction thereof may be coupled to the first pin-hole 261 and the second pin-hole 262. A rivet hole (not shown) is formed in the approximately central portion between the first pin-hole 261 and the second pin-hole 262. A pair of the guide plate members 220 is connected to each other by a rivet 231 which has passed through the rivet hole. The rivet 231 is inserted and fixed to a rivet recess 351 to be described below of the connector 300. Here, the first pin-hole 261 and the second pin-hole 262 may be formed to have different sizes in such a manner as to be selectively coupled to the wiper arm “pa” in accordance with the size of the wiper arm “pa”.

When a below-described side pin-hole type wiper arm is inserted and fixed to the first pin-hole 261 or the second pin-hole 262, the embossed member 230 formed on the outer wall of the guide plate member 220 reduces a gap generated between the guide plate member 220 and the side pin-hole type wiper arm. Therefore, it is possible to prevent the wiping performance deterioration or vibration, etc., caused by a gap at the time of pivoting of the wiper arm.

FIG. 8 is a perspective view showing that the embossed member has been formed around the first pin-hole 261 and the second pin-hole 262.

Referring to FIG. 8, the embossed member 230 may be formed contacting with the first pin-hole 261 and the second pin-hole 262. Therefore, the embossed member 230 should not necessarily be separated from the first pin-hole 261 or the second pin-hole 262. The embossed member 230 may be formed to project from the outer wall of the guide plate member 220 into contact with the first pin-hole 261 and the second pin-hole 262. Since the circumference of the pin-hole of the guide plate member 220 protrudes, the embossed member 230 reduces the gap at the closest position where the gap may occur, thereby more effectively preventing the gap.

Hereafter, the flat wiper blade assembly according to the embodiment will be described in detail with reference to an example where the flat wiper blade assembly is coupled to the pin-hole typed wiper arm in the side direction among a variety of wiper arms.

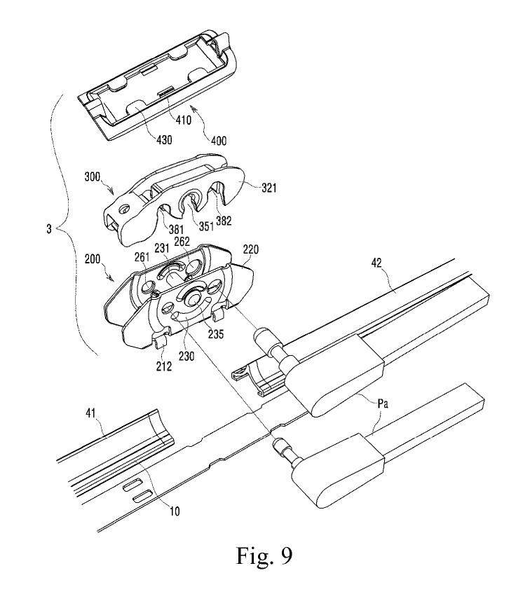

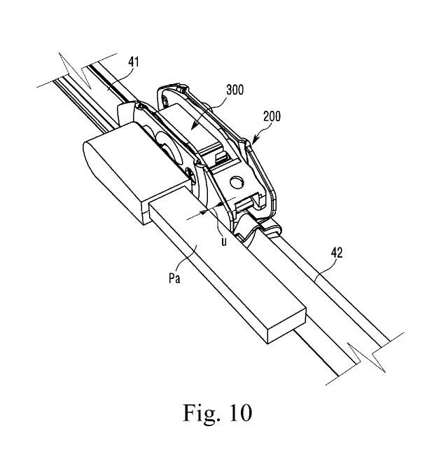

FIG. 9 is a perspective view showing that the flat wiper blade assembly according to the present invention has been separated from the wiper arm. FIG. 10 is a perspective view showing that the flat wiper blade assembly according to the present invention has been coupled to the wiper arm of FIG. 9.

As shown in FIGS. 1 and 9, the flat wiper blade assembly 1 includes the flat wiper blade 2 and the adaptor part 3.

Since the configuration of the flat wiper blade 2 is the same as that described above, a detailed description thereof will be omitted.

The adaptor part 3 includes the adaptor 200, the connector 300 and the cover 400.

Referring to FIGS. 4 and 9, the shape of the body 210 of the adaptor 200 is the same as that described above. The first pin-hole 261 and the second pin-hole 262 are formed on the middle end of the guide plate member 220 of the adaptor 200. The wiper arm “pa” with a pin projecting in the side direction thereof may be coupled to the first pin-hole 261 and the second pin-hole 262. The rivet hole (not shown) is formed in the approximately central portion between the first pin-hole 261 and the second pin-hole 262.

Also, a pair of the guide plate members 220 is connected to each other by the rivet 231 which has passed through the rivet hole. The rivet 231 is inserted and fixed to the rivet recess 351 to be described below of the connector 300. Here, the first pin-hole 261 and the second pin-hole 262 may be formed to have different sizes in such a manner as to be selectively coupled to the wiper arm “pa” in accordance with the size of the wiper arm “pa”.

The embossed member 230 is formed to project outwardly from the outer wall of guide plate member 220. In a pair of the guide plate members 220, portions corresponding to the embossed member 230 are formed inwardly concave in mutually facing inner walls of a pair of the guide plate members 220. Here, since the guide plate member 220 includes the embossed member 230, a plate member having a thickness of 1.2 T to 1.3 T can be used as the guide plate member 220.

Meanwhile, as shown in FIG. 9 and FIG. 10, since a rivet head 235 of the rivet 231, which has passed through the rivet hole of the guide plate member 220, projects outwardly from the guide plate member 222, a gap “U” is generally created between the flat wiper blade assembly and the wiper arm “pa” by the rivet head 235. In the flat wiper blade assembly 1 according to the embodiment, since the embossed member 230 is formed to project outwardly from the guide plate member 220 just like the rivet head 235 is formed to project, the gap “U” is not required.

The connector 300 includes a pair of inner side plates 321 contacting with a pair of the guide plate members 220, the rivet recess 351 which is formed in the central portion of the inner side plate 321 and inserted and fixed to the rivet 231 of the guide plate member 220, and a first pin coupling recess 381 and a second pin coupling recess 382 of which the lower portion is opened such that the pin of the wiper arm “pa” passes through the inner side plate 321. Here, the first pin coupling recess 381 contacts with the first pin-hole 261, and the second pin coupling recess 382 contacts with the second pin-hole 262.

In the cover 400, a fitting protrusion member 410 to which the fitting hole member 214 of the adaptor 200 may be inserted and fixed is formed to project in the width direction of the cover 400. Also, in the cover 400, an auxiliary member 430 on which the projecting member 212 of the adaptor 200 may be placed is formed to project in the width direction.

As shown in FIGS. 4, 9 and 10, it is desirable that the gap between the both side members of the cover 400 is larger than the width of the adaptor 200 such that a portion of the adaptor 200, which is coupled to the frame 30, is enclosed from the both sides. The hole size of the fitting hole member 214 may be larger than the protrusion size of the fitting protrusion member 410 of the cover 400. The strength suppressing the separation between the adaptor 200 and the cover 400 is increased with the reduction of the size difference between the hole of the fitting hole member 214 and the protrusion of the fitting protrusion member 410.

According to the above-described configuration, the projecting member 212 encloses the fitting recess member 33 of the frame 30 from the outside, so that the adaptor 200 is fixed to the frame 30.

The rivet recess 351 is inserted and fixed to the rivet 231, so that the connector 300 is inserted and pivoted between the guide plate members 220 of the adaptor 200.

In a state where the adaptor 200 is fixed to the frame 30, the cover 400 is fixed to the adaptor 200 by inserting the fitting protrusion member 410 into the fitting hole member 214 of the adaptor 200. Here, the auxiliary member 430 of the cover 400 is placed on the projecting member 212 of the adaptor 200, thereby preventing the cover 400 from hanging down.

As described above, in the flat wiper blade assembly 1 according to the embodiment, a pair of the guide plate members 220 includes the embossed member 230. As a result, the embossed member 230 functions to sustain the guide plate member 220, so that the rigidity of the guide plate member 220 is enhanced.

Further, when the flat wiper blade assembly 1 according to the embodiment is coupled to the wiper arm “pa”, it is possible to reduce the gap created by the rivet head of the rivet 231 which has passes through the rivet hole of the guide plate member 220, so that the quality of the product is improved. That is, since the embossed member 230 is placed around the above-described gap “U”, the flat wiper blade assembly 1 according to the embodiment does not require the gap “U”, and thus it is possible to enhance the quality of the product.

The present invention is not limited to the embodiment described above and the accompanying drawings. The scope of rights of the present invention is intended to be limited by the appended claims. It will be understood by those skilled in the art that various substitutions, modification and changes in form and details may be made therein without departing from the spirit and scope of the present invention as defined by the appended claims. The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A flat wiper blade assembly comprising:
a flat wiper blade; and
an adaptor part which includes
an adaptor including a pair of guide plate members which is connected to the flat wiper blade and projects perpendicularly at an interval, and
a connector which is coupled to the adaptor and couples a wiper arm to the flat wiper blade,
wherein a pair of the guide plate members includes an embossed member formed on an outer wall thereof.

2. The flat wiper blade assembly of claim 1, wherein the guide plate member has a thickness of 1.2T to 1.3 T.

3. The flat wiper blade assembly of claim 1, wherein the guide plate member has a shape in which the embossed member projects outwardly from the outer wall and in which portions corresponding to the embossed member are formed inwardly concave in mutually facing inner walls.

4. The flat wiper blade assembly of claim 1, wherein the embossed member is formed to comprise a plurality of ribs separated from each other at a predetermined interval.

5. The flat wiper blade assembly of claim 1, wherein the adaptor comprises a first pin-hole and a second pin-hole to which the wiper arm is coupled in a side direction thereof, and wherein the embossed member is formed to contact with the first pin-hole and the second pin-hole.

6. The flat wiper blade assembly of claim 1, further comprising a cover which is fixed to the adaptor coupled to the flat wiper blade and is used to prevent impurities.

7. The flat wiper blade assembly of claim 6, wherein a width of the cover is greater than that of the adaptor.
